(19) United States
(12) Patent Application Publication
(10) Pub. No.: US 2006/0247048 A1
(43) Pub. Date: Nov. 2, 2006

(54) Universal button module

(76) Inventors: Michael J. Mitchell, Las Vegas, NV (US); Robert A. Luciano JR., Reno, NV (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/223,364

(22) Filed: Sep. 9, 2005

Related U.S. Application Data
(63) Continuation-in-part of application No. 11/106,212, filed on Apr. 14, 2005.

(51) Int. Cl. A63F 13/00

(52) U.S. Cl. 463/37

(57) ABSTRACT

The present invention relates to a universal button module for use in connection with a machine, including a gaming machine. The universal button module is adaptable to perform particular functions in gaming machines such as controlling the selection of the number of pay lines to play or the number of credits to bet per pay line. Additionally, the universal button module comprises a display button positioned between the first button portion and the second button portion, wherein the display button portion displays information and may be manipulated to activate a function.

### CROSS-REFERENCE TO RELATED APPLICATIONS

This application is a continuation-in-part of U.S. application Ser. No. 11/106,212 filed Apr. 14, 2005, the disclosure of which is herein incorporated by reference in its entirety.

### BACKGROUND

Current gaming machines have hardwired pre-configured button panels that correspond to particular games offered for play on the gaming machine. The pre-configured button panels provide the appropriate amount of buttons needed to properly operate the provided games on the gaming machine. For example, if a game requires the use of three buttons to play the game, the button panel will typically have at least three buttons.

To function properly, any new games placed on a gaming machine must be compatible with the pre-configured traditional button panel system. Otherwise, the panel must be physically changed. For example, if a new game requires the use of twelve buttons to play the game and the gaming machine has a button panel with only six buttons, the new game will generally not function properly with the existing gaming machine button panel. As a result, the button panel will require a physical change or the new game will not be able to be played effectively on the gaming machine.

Additionally, in current gaming systems, the buttons are designed to perform a particular function. In games having multiple pay lines, buttons are provided to enable a user to select a particular number of pay lines. Generally, gaming machines provide button panels with a set of hard-wired buttons that are associated with a particular function. For example, in a game offering six pay lines, the gaming machine will typically have a button panel with a set of buttons representing a range of values for selecting the number of pay lines to bet. This hard-wired button panel, however, will not necessarily work well with other games. If a new game offering ten pay lines is placed on the gaming machine there will not be enough buttons to enable every number of pay lines to be bet. Thus, having the capability of activating or selecting any number of the pay lines would require physically changing the button panel and adding more buttons.

Alternatively, other new games added to a gaming machine might require different physical changes to the button panel such as re-labeling the button caps rather than changing the actual number of buttons on the button panel.

Physically changing and altering the buttons on a button panel can be a time-consuming and costly process. What is needed is a button system that may be adapted for use in a plurality of gaming systems without requiring substantial or major physical modification of the button panel.

Additionally, in multi-denominational machines a player may select whether a credit is worth a penny, a nickel, a quarter, a dollar, etc. It is undesirable to use the same math model for a penny game as for a $5 game. A penny game might offer a 92% return and a $5 game might offer a 98% return. Accordingly, as a player makes a denomination selection, gaming machines typically switch to a math model that corresponds to that selection. The same game title and theme are used but the wagering options change. The machine generally loads a separate version of the game already resident on the machine. Generally speaking, the higher the denomination, the fewer the pay lines that are offered. A $1 game might only offer 3 or 5 lines at 5-10 credits per line. Whereas, a ½ cent game might offer 20 lines at 20 credits per line.

These radical differences in betting options make it difficult to maintain the same fixed button labeling patterns on the wagering rows across all math models. The more credits available for wagering, the bigger the holes become in the bet patterns.

Reducing the number of pay lines as a player switches to a higher denomination can lead to fewer usable buttons on the button deck. Unusable buttons lead to player confusion.

What is needed is a button system that simplifies the player controls by reducing the number of buttons and does not require the physical modification of the labels on the controls as different games are played.

### SUMMARY

Briefly, and in general terms, various embodiments of a universal button module are disclosed herein. One embodiment is directed to a gaming machine comprising a cabinet having a game display, a playing deck, one or more games having one or more pay lines, and one or more universal button modules. The universal button module controls the selection of the number of pay lines to play in a game or the number of credits to bet per pay line in a game.

In another embodiment, the universal button module is for use in connection with a gaming machine. The universal button module comprises a first button portion for increasing the number of pay lines to play or the number of credits to bet per pay line, and a second button portion for decreasing the number of pay lines to play or the number of credits to bet per pay line. Additionally, the universal button module comprises a display button portion positioned between the first button portion and the second button portion. The display button portion displays information and may be manipulated to activate a function. Optionally, one or more button portions of the universal button module may be illuminated.

Additionally, in another embodiment, the universal button module comprises a coating covering at least a portion of the universal button module, wherein the coating comprises a texturized material. Alternatively, a slip-resistant material covers at least a portion of the universal button module.

Alternatively, another embodiment is directed to a universal button module for use in connection with any machine. The types of machine may include an automated teller machine, a vending machine, a gaming machine, or any other machine that uses buttons. The universal button module comprises a first button portion for controlling a first function in connection with the machine, and a second button portion for controlling a second function in connection with the machine. Additionally, the universal button module comprises a display button portion positioned between the first button portion and the second button portion. The display button portion displays information and may be manipulated to activate a function.

### BRIEF DESCRIPTION OF THE DRAWINGS

FIG. 1 is an illustration of a gaming machine comprising an embodiment of a universal button module.

FIG. 2 is an illustration of an embodiment of a universal button module for use in a gaming system.

FIG. 3 is an illustration of an embodiment of a universal button module on a gaming machine.

FIG. 4 is an illustration of an embodiment of a universal button module for use in a gaming system.

FIG. 5 is an illustration of an embodiment of a universal button module for use in a gaming system.

FIG. 6 is an illustration of an embodiment of a universal button module for use in a gaming system.

FIG. 7 is an illustration of a gaming machine comprising an embodiment of a universal button module.

FIG. 8 is an illustration of a gaming machine comprising an embodiment of a universal button module.

FIG. 9A is an illustration of an additional form of a universal button module.

FIG. 9B is an illustration of an additional form of a universal button module.

FIG. 10 is an illustration of an embodiment of a universal button module.

FIG. 11 is an illustration of an embodiment of a universal button module.

FIG. 12 is an illustration of an embodiment of a universal button module.

FIG. 13 is an illustration of an embodiment of a universal button module.

FIG. 14 is an illustration of an embodiment of a universal button module.

### DETAILED DESCRIPTION

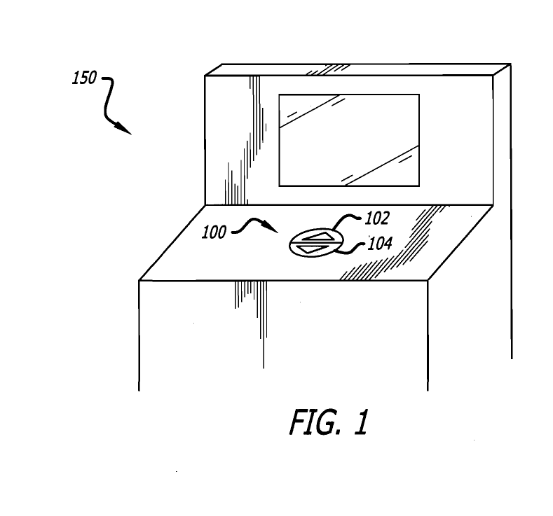

Various embodiments are directed to a universal button module for use with a plurality of different gaming systems. More particularly, the universal button module provides a dynamic button system adaptable for use with various games and capable of adjusting to gaming systems having frequent game changes. The adaptability of the universal button module alleviates the costly and time consuming process of having to physically change the button panels when new games are added to or changed within a gaming machine. Embodiments of the system and method are illustrated and described herein, by way of example only, and not by way of limitation. Referring now to the drawings, wherein like reference numerals denote like or corresponding parts throughout the drawings and, more particularly to FIGS. 1-13, there is shown a universal button module.

In one embodiment, the universal button module has the capability and functionality to be used with a multitude of games. Referring now to FIG. 1, a universal button module 100 for use in connection with a gaming machine 150 is illustrated. The universal button module 100 comprises a first button portion 102 for incrementing a value and a second button portion 104 for decrementing a value. The universal button module 100 may be used in connection with playing a game on the gaming machine 150, wherein the game has a set number of pay lines. In this example, the universal button module is used to select a number of pay lines to play in the game. A user may select to play any number of pay lines ranging between a minimum value, such as one, and a maximum value (i.e. the maximum number of pay lines). The first button portion 102 is manipulated or depressed to increase the number of pay lines to be played and the second button portion 104 is manipulated or depressed to decrease the number of pay lines to be played.

In another example, the universal button module is used to select the credits wagered or bet per pay line. In this example, the first button portion 102 is manipulated or depressed to increase the number of credits to bet per pay line and the second button portion 104 is manipulated or depressed to decrease the number of credits to bet per pay line.

In one embodiment, the first button portion 102 may be tapped to incrementally increase the number of credits bet per pay line. Similarly, the second button portion 104 may be tapped to decrease the number of credits bet per play line. In an alternative embodiment, the first button portion 102 may be depressed or “held down” to gradually accelerate the increase in the number of credits bet per play line. Likewise, the second button portion 104 may be depressed or “held down” to gradually accelerate the decrease in the number of credits bet per play line.

In another embodiment, the universal button module is used in connection with a gaming machine capable of downloading gaming data. The gaming data may be downloaded via a network connection. Optionally, in an alternative embodiment, the gaming data may be downloaded on demand.

Alternatively, the gaming data may be transferred to the gaming machine via other well known data transfer means. By way of example, but not by limitation, such means include external memory devices, dongles, hard drives, CD-roms, DVD, and wireless technology.

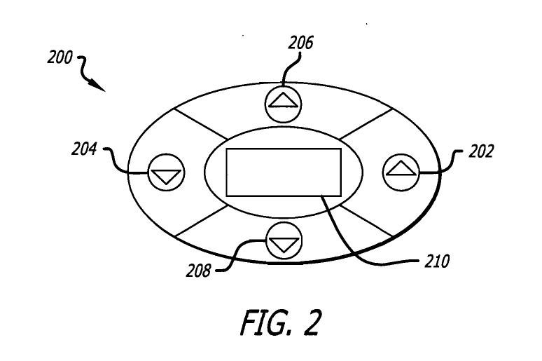

FIG. 2 illustrates an alternative embodiment of the universal button module, which may also be used in connection with a gaming machine. The universal button module 200 has a first button portion 202 for incrementing a value and a second button portion 204 for decrementing a value. Additionally, the universal button module 200 has a display 210 for displaying the value selected. The universal button module 200 may be used to select the number of pay lines to play in a game. The first button portion 202 and second button portion 204 may be manipulated to obtain the desired number of pay lines to play. As the first button portion 202 and second button portion 204 are being manipulated, the current number of pay lines is displayed in the display 210. Once the desired number of pay lines is obtained, the number is selected.

The universal button module 200 may also be used to select credits to bet per pay line. The first button portion 202 and second button portion 204 may be manipulated to obtain the desired amount of the bet or wager. The display 210 shows or displays the value of the credits bet.

In one embodiment, the amount bet per pay line is the same for each pay line. In an alternate embodiment, the amount bet per pay line may vary for each pay line.

Optionally, in a separate embodiment, the universal button module 200 may be used to select particular pay lines in a game. The first button portion 202 and second button portion 204 may be manipulated to select particular pay lines. In one example of this embodiment, a game has ten pay lines and each of the ten pay lines is uniquely identified. The universal button module 200 may be used to particularly select any of the ten uniquely identified pay lines. Additionally, in an optional embodiment, a particular bet or wager may then be designated to each particularly selected pay line.

Referring back to FIG. 2, in an optional embodiment, the universal button module 200 has a third button portion 206 for selecting a maximum value and a fourth button portion 208 for selecting a minimum value. In another embodiment, where the universal button module 200 is used to select the number of pay lines to play in a game, the third button portion 206 automatically selects the maximum number of pay lines to play and the fourth button portion 208 automatically selects the minimum number of pay lines to play. In another embodiment, where the universal button module 200 is used to select the number of credits to bet per pay line, the third button portion 206 automatically selects the maximum number of credits to bet per pay line and the fourth button portion 208 automatically selects the minimum number of credits to bet per pay line. The above embodiment is not intended to limit the universal button module to four button portions, but rather is meant to serve as an illustration of one embodiment. The universal button module may have an unlimited number of button portions.

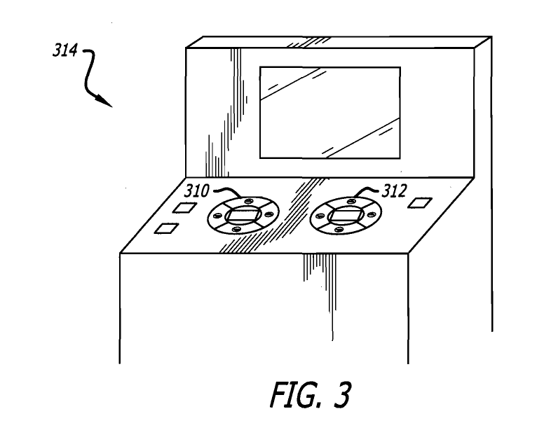

FIG. 3 shows universal button modules 310 and 312 located on a gaming machine 314. The universal button module 310 is used to select the number of pay lines to play in a game and the universal button module 312 is used to select the number of credits to bet per pay line.

As those skilled in the art will appreciate, numerous methods exist and are known for connecting buttons, lights and displays to gaming machines. Examples of some of the many connection methods are described as follows for illustrative purposes only and are not meant as a limitation. In some embodiments, the universal button modules are connected directly to the gaming machine. For example, the universal button module can be wired directly into the backplane of the gaming machine. In another embodiment, the universal button module is connected to a separate controller by a serial, parallel, USB, or any other peripheral connection. Alternatively, in-a different embodiment, the universal button controller is connected to a generic device controller unit. Such a unit is disclosed in U.S. patent application Ser. No. 09/746,854, Publication No. 2002/0019891 A1, which is incorporated herein by reference. Optionally, in another embodiment, the universal button module may be connected wirelessly to the gaming machine. Additionally, in an optional embodiment where a universal button module connects wirelessly to a gaming machine, the universal button module is not physically connected to the gaming machine.

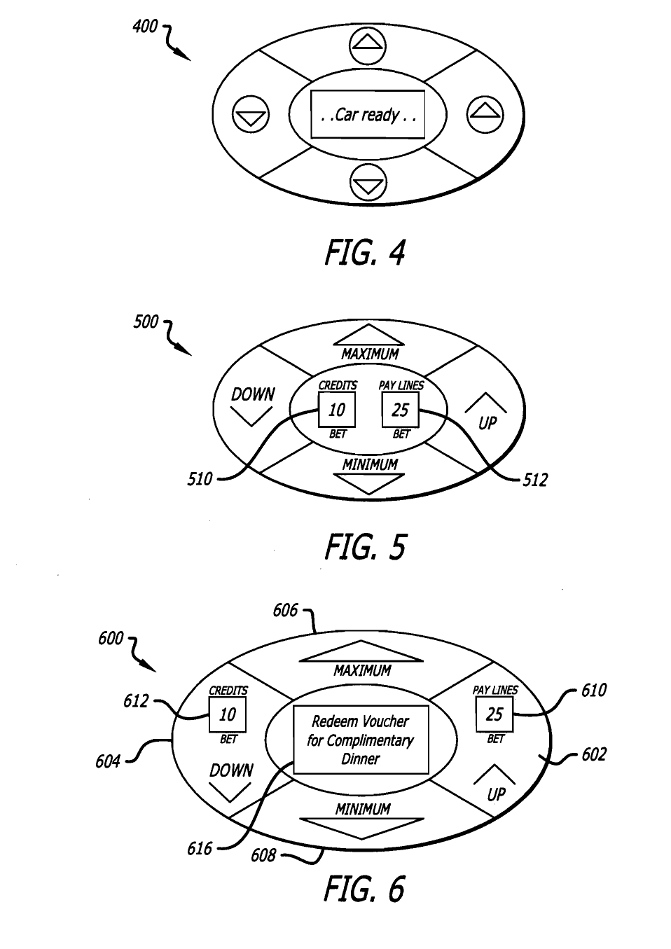

Referring back to FIG. 2, the display 210 on the universal button module 200 may comprise any number or type of display technologies, such as, but not limited to Light Emitting Diodes (LEDs), organic LEDs, Liquid Crystal Displays (LCDs), Vacuum Fluorescent Displays (VFDs) or any other display technologies for providing visual output to the player or to anyone using the universal button module. Such output includes, but is not limited to, the number of pay lines sought to be bet, the number of credits sought to be bet, or other text based information such as when a table is ready at a restaurant, when a car is ready for pick-up, when extra credits have been earned, promotional information, diagnostics, instant messaging from others, information for accounting audits and animated graphics. FIG. 4 illustrates a universal button module 400 displaying a textual message.

Optionally, in alternative embodiments, each universal button module can have one or more displays. FIG. 5 illustrates an example of a universal button module 500 having a display 510 and a display 512. In another embodiment, one or more displays may be found in only one of the two or more universal button modules. In still another embodiment, the universal button modules may have no displays, but may be associated with one or more displays located elsewhere on the machine. For example, the play screen on the main game may show the results of the number of pay lines selected to be played in a game or the number of credits selected to be bet in a game.

Alternatively, in another embodiment, one or more button portion may have a display. Referring now to FIG. 6, a universal button module 600 is shown. The universal button module 600 comprises button portions 602, 604, 606 and 608. Button portion 602 has a display 610 and button portion 604 has a display 612. Additionally, universal button module 600 has a display 616 for outputting textual information. FIG. 6 shows a promotional message for a complimentary dinner. However, it is understood that any type of textual information may be displayed in the display 616.

Referring back to FIG. 2, in alternative embodiments, the universal button module 200 may be used to perform functions other than selecting pay lines and credits per bet. For example, the universal button module may be used to select the speed of the game presentation, game audio volume and other player-preference options. In still other alternative embodiments, the universal button module 200 may be used by a gaming machine technician to navigate through diagnostic or accounting menus or to set gaming machine options such as, but not limited to, screen contrast, high credit meter limit and collect lockup limit.

In another embodiment, the universal button module is an intelligent module that is capable of operating in connection with a machine while operating independently from the main CPU of the machine. For example, referring back to FIG. 2, an intelligent universal button module 200 can be used in connection with a gaming machine. The universal button module 200 is capable of receiving and accepting all necessary gaming data such that it operates independently from the main CPU of the gaming machine.

In another embodiment, the universal button module is an intelligent module that receives gaming data via a downloaded game. The downloaded game contains all the required intelligence for the button to operate. Such intelligence includes, but is not limited to, determining button values, such as the maximum and minimum button values, determining button labels, textual display information, etc.

In another embodiment, the universal button module 200 may be used as an input device for the play of a bonus game. The first button portion 202 and the second button portion 204 may be manipulated in some fashion to control and play a bonus game offered for play on a gaming machine. Alternatively, in yet another embodiment, the universal button module 200 may be used to move a cursor around on a display screen and to make a selection.

Additionally, in an optional embodiment, two or more universal button modules may be used in combination to provide additional actions and/or functionality. For example, simultaneously pushing the two top buttons from two different universal button modules can initiate a max bet on all pay lines, lock-in credits for each pay line one at a time, or activate an additional function or feature.

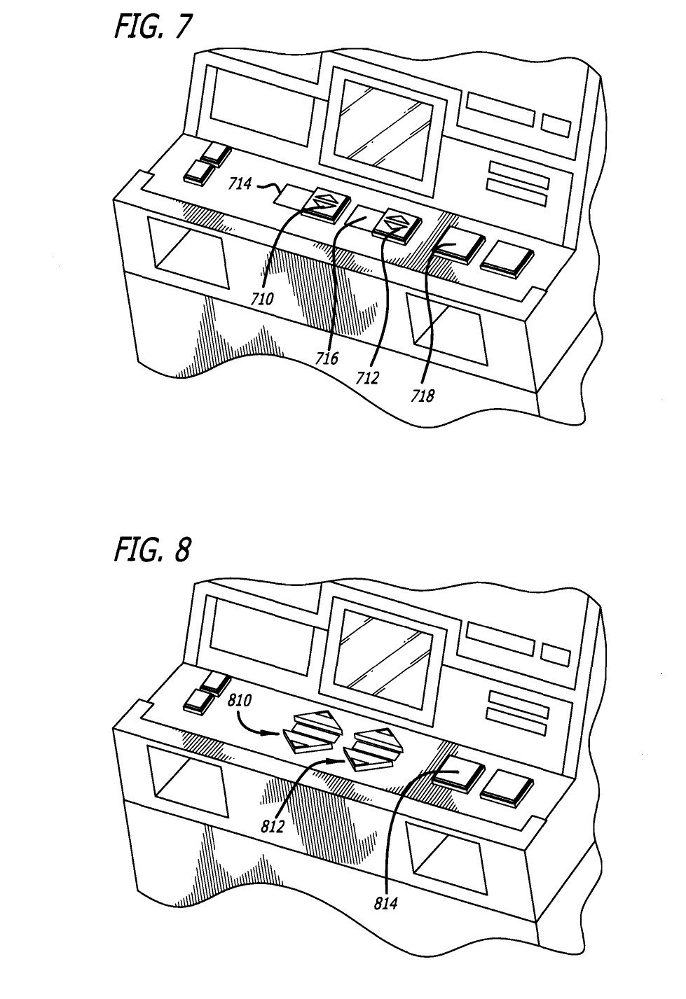

Additionally, the universal button module can vary in size and shape to maximize the look and feel of the button deck and the efficiency and functionality thereof. Referring to FIG. 7, two square universal button modules are illustrated. Specifically, square universal button modules 710 and 712 are shown. Additionally, displays 714 and 716 are adjacent to each of the respective universal button modules, 710 and 712. Also, a max bet button 718 is located separate from the universal button modules. Activation of the max bet button 718 automatically sets the wager as the maximum bet amount.

In another embodiment, as shown in FIG. 8, portions of the universal button modules 810 and 812 are in the shape of a triangle. Additionally, each universal button module 810 and 812 further comprises a display in the center of the module. A max bet button 814 is located separately on the button panel.

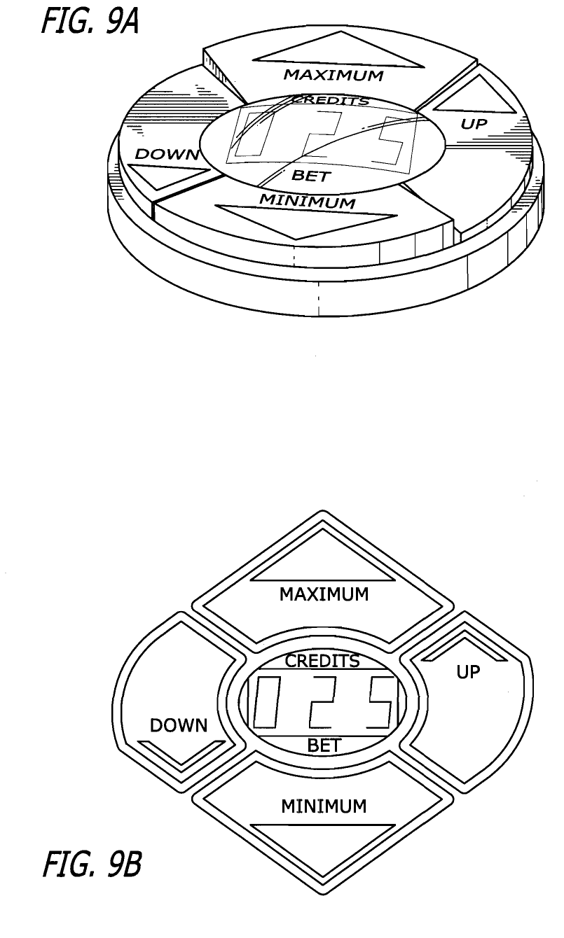

FIG. 9A and FIG. 9B illustrate additional examples of possible shapes for use with the universal button module. As those skilled in the art will appreciate, the universal button module may have any shape such as, but not limited to, an ellipse, circle, trapezoid, rhombus, or any other polygonal or free-form shape.

In an optional embodiment, the universal button module can be lit up. The universal button module can have internal lighting, back lighting, a lit bezel or any other well known lighting technique. Additionally, the lights can consist of any color scheme and may flash or remain static. The lighting of the universal button module can be configured such that the color scheme reflects a game theme.

Alternatively, one or more button portions of the universal button module may be illuminated. The button portion may be entirely illuminated, or optionally, it may be partially illuminated.

In another embodiment, a universal button module acts as a toggle switch. Additionally, a display may be located in the center of the universal button module and the universal button module may be rocked forward to raise the number credits, and rocked backward to lower the number of credits. Likewise, the universal button module may be rocked to the sides to implement other functions.

Optionally, in an alternative embodiment, a universal button module comprises a display toggle switch located in the center of the universal button module. The display may be rocked forward to raise the number credits, and rocked backward to lower the number of credits. Likewise, the display may be rocked to the sides to implement other functions.

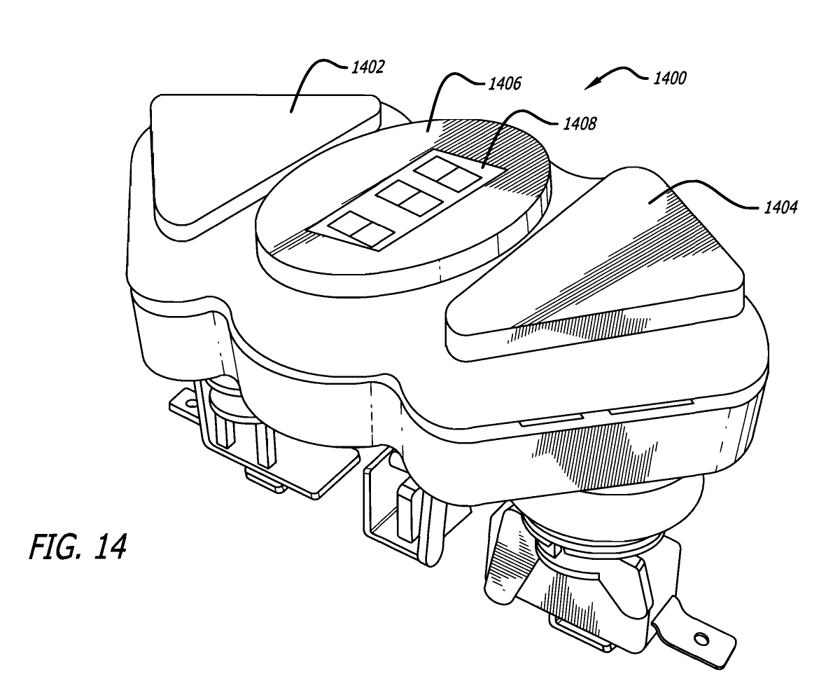

In another embodiment, a universal button module comprises a display button located in the center of the universal button module. Referring to FIG. 14, the universal button module 1400 comprises a first button portion 1402 and a second button portion 1404. Additionally, the universal button module 1400 comprises a display button 1406 located in the center of the module between the first button portion 1402 and the second button portion 1404. The center display button 1406 comprises a display 1408 for displaying information. The display 1408 may be smaller than the center display button 1406 (as shown). Optionally, the display 1408 may be as large as the center display button 1406 (not shown).

The center display button 1406 may be manipulated or depressed to raise or lower the number of credits. Likewise, the center display button 1406 may be manipulated or depressed to implement or activate other functions. Optionally, the center display button 1406 may be toggled to implement or activate a function. As those skilled in the art will appreciate, there are numerous known methods and techniques for activating a button, all of which could be utilized for operating the universal button module.

Additionally, the universal button module 1400 may be configured to change functionality depending on the length of the press of a button portion. For example, upon being pressed for a predetermined length of time (e.g., several seconds), the functionality of the center display button 1406 can change. Typically, when the button is pressed in an intermittent fashion, it will speed up the changes it is stepping through. Additionally, other functional changes can be triggered based on length of time pressed.

Optionally, the universal button module may incorporate a color scheme to represent particular functions. More particularly, one or more of the button portions in the universal button module can have a functionality change indicated by a change in color. That is, the color communicates or makes obvious to a player that the button functions have changed. For example, blue colored buttons perform a particular function and red one or more red colored buttons perform another different function.

In one embodiment a universal button module having color-changing button portions is used with a gaming machine that allows a player to choose different games. The button portions may be blue, green or red in color, depending on the game being played. For example, the buttons are blue when a stud poker game is being played, the buttons are green when a draw poker game is being played, and the buttons are red when a slot game is being played. One or more tri-colored LEDs may be positioned behind the buttons to change their colors or to simply illuminate them.

Optionally, the display button may be located in the center of a universal button modules having more than two buttons. For example, a universal button module having four buttons portions may additionally comprise a display button. Referring back to FIG. 2 a universal button module 200 having four button portions 202, 204, 206 and 208 is shown. In one embodiment, the display 210 may be a display button 210, wherein the display button may be depressed to implement or activate other functions. Alternatively, the button display does not need to be located in the center of the universal button module, but rather may be located at any location on the universal display module.

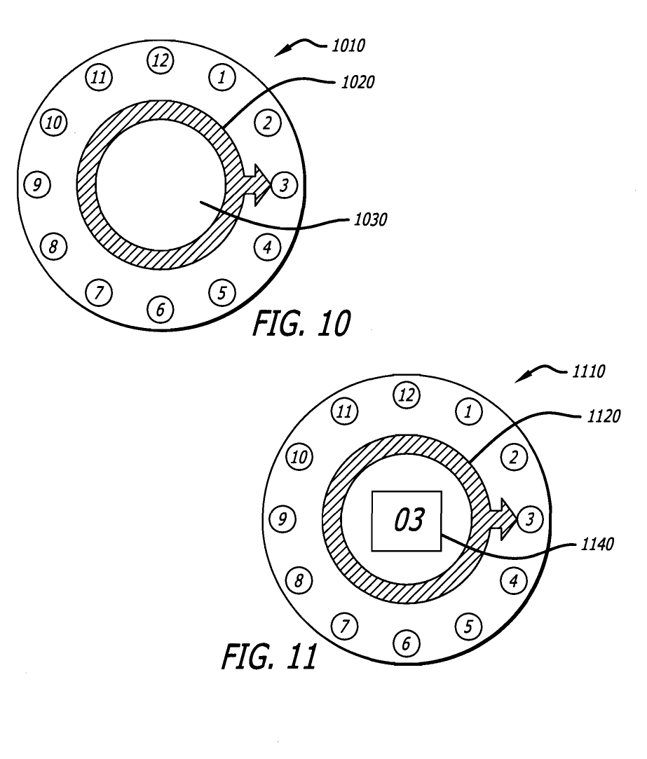

Similarly, the universal button module may be rotated to increment and decrement various functions. An example of one embodiment is shown in FIG. 10 where a universal button module 1010 in the form of a radio knob is illustrated. A knob 1020 is used to select the number of pay lines to play in a game or the number of credits to bet in a game. The center portion 1030 of the knob 1020 may be depressed to make a number selection. FIG. 11 illustrates another embodiment of a universal button module 1110 also in the form of a radio knob. A knob 1120 is used to select the number of pay lines to play in a game or the number of credits to bet in a game. A display 1140 displays the number of pay lines or credits selected. Alternatively, in a different embodiment, the display 1140 could show various other types of textual information.

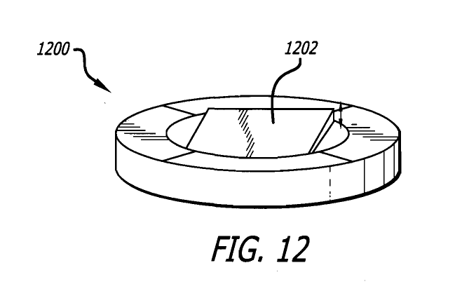

In an additional embodiment, a universal button module comprises a moveable display portion. Referring now to FIG. 12, a universal button module 1200 having a display portion 1202 is illustrated. The display portion 1202 can tilt to provide more flexibility and to adjust the angle of the display portion for easier and clearer viewing of the information displayed.

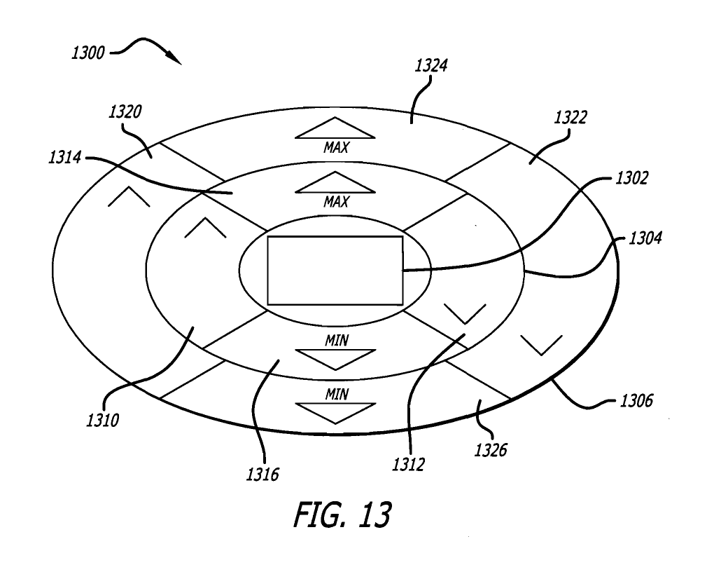

Additionally, in an optional embodiment, the universal button module comprises multiple control or display portions that are moveable relative to one another. In the example embodiment illustrated in FIG. 13, a universal button module 1300 is illustrated. The universal button module 1300 comprises a display 1302, an inner control portion 1304 and an outer control portion 1306. The inner control portion 1304 comprises button portions 1310, 1312, 1314, and 1316. The outer control portion 1306 comprises button portions 1320, 1322, 1324 and 1326.

In one embodiment, the inner control portion 1304 is used to select the number of pay lines to play in a game and the outer control portion 1306 is used to select the number of credits to bet per pay line. In the inner control portion 1304, the button portion 1310 increases the number of pay lines to play and the button portion 1312 decreases the number of pay lines to play. The button portion 1314 is a maximum pay line button for automatically selecting the maximum allowable number of pay lines to play. The button portion 1316 is a minimum pay line button for automatically selecting the minimum permissible number of pay lines to play. In the outer control portion 1306, the outer button portion 1320 increases the number of credits to bet per pay line and the button portion 1322 decreases the number of credits to bet per pay line. The button portion 1324 is a maximum pay line button for automatically selecting the maximum allowable number of credits to bet per pay line. The button portion 1326 is a minimum pay line button for automatically selecting the minimum permissible number of credits to bet per pay line.

The display 1302 can display the data associated with the control portion of the universal button module 1300 being activated. For example, the display 1302 can show the number of credits bet per line for the game when the outer control portion 1306 is activated or in use. Additionally, the display 1302 can show the number of lines to play in a game when the inner control portion 1304 is activated or in use.

In an alternative embodiment, the inner control portion 1304 is used to select the number of credits to bet per pay line and the outer control portion 1306 is used to select the number of pay lines to play in a game. In this alternative embodiment, the button portion 1310 increases the number of credits to bet per pay line and the button portion 1312-decreases the number of credits to bet per pay line. The button portion 1314 is a maximum pay line button for automatically selecting the maximum allowable number of credits to bet per pay line. The button portion 1316 is a minimum pay line button for automatically selecting the minimum permissible number of credits to bet per pay line. In the outer control portion 1306, the button portion 1320 increases the number of pay lines to play and the button portion 1322 decreases the number of pay lines to play. The button portion 1324 is a maximum pay line button for automatically selecting the maximum allowable number of pay lines to play. The button portion 1326 is a minimum pay line-button for automatically selecting the minimum permissible number of pay lines to play. The display 1302 shows information associated with the control portion activated or in use.

Optionally, a universal button module may be coated with a texturized material. The material may cover a portion of the universal button module, such as only one or more button portions. Alternatively, the material may cover the entire module. The coating is a slip-resistant material that allows the user to better grip and manipulate the universal button module, or a portion thereof. Optionally, a rubber material may be used to provide the user with better handling capabilities. For example, the rubber material may be positioned on the universal button module to better maintain a user's grip and prevent a user's hand from slipping during use.

The universal button module may be used in any environment wherein a button panel is used and it is desirable to add functionality without physically changing the button panel. Fore example, the universal button module may be used on automated teller machines (ATMs) and vending machines.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims

1. A universal button module for use in connection with a gaming machine, comprising:
a first button portion for increasing the number of pay lines to play or the number of credits to bet per pay line;
a second button portion for decreasing the number of pay lines to play or the number of credits to bet per pay line; and
a display button portion positioned between the first button portion and the second button portion, wherein the display button portion displays information and may be manipulated to activate a function.

2. The universal button module of claim 1, wherein the display button portion may be depressed to activate a function.

3. The universal button module of claim 1, wherein the display button portion may be toggled to activate a function.

4. The universal button module of claim 1, wherein one or more of the button portions are illuminated.

5. The universal button module of claim 1, wherein one or more of the button portions display a particular color, and the particular color corresponds to a particular game.

6. The universal button module of claim 1, wherein the display button portion is positioned approximately in the center of the universal button module.

7. The universal button module of claim 1, further comprising a coating covering at least a portion of the universal button module, wherein the coating comprises a texturized material.

8. The universal button module of claim 1, further comprising a slip-resistant material covering at least a portion of the universal button module.

9. A universal button module for use in connection with a machine, comprising:
a first button portion for controlling a first function in connection with the machine;
a second button portion for controlling a second function in connection with the machine; and
a display button portion comprising a display for outputting information, wherein the display button portion may be manipulated to activate a function.

10. The universal button module of claim 9, wherein the display button portion may be depressed to activate a function.

11. The universal button module of claim 9, wherein the display button portion may be toggled to activate a function.

12. The universal button module of claim 9, wherein the display button portion is located between the first button portion and the second button portion.

13. The universal button module of claim 9, further comprising one or more additional button portions.

14. The universal button module of 9, wherein the display button portion is positioned approximately in the center of the universal button module.

15. The universal button module of claim 9, wherein one or more of the button portions are illuminated.

16. The universal button module of claim 9, wherein one or more of the button portions display a particular color, and the particular color corresponds to a particular game.

17. The universal button module of claim 9, further comprising a coating covering at least a portion of the universal button module, wherein the coating comprises a texturized material.

18. The universal button module of claim 9, further comprising a slip-resistant material covering at least a portion of the universal button module.

19. The universal button module of claim 9, wherein the universal button module is located on a gaming machine and the gaming machine comprises:
a cabinet having a game display;
a playing deck; and
one or more games having one or more pay lines.
